(19) United States
(12) Patent Application Publication
(10) Pub. No.: US 2010/0179712 A1
(43) Pub. Date: Jul. 15, 2010

(54) TRANSPARENT VEHICLE SKIN AND METHODS FOR VIEWING VEHICLE SYSTEMS AND OPERATING STATUS

(75) Inventors: Dave Pepitone, Sun City West, AZ (US); Roger W. Burgin, Scottsdale, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/354,276

(22) Filed: Jan. 15, 2009

(51) Int. Cl. G06F 19/00; G01C 23/00

(52) U.S. Cl. 701/14; 340/971; 701/213

(57) ABSTRACT

Systems and methods for viewing systems and status of a vehicle are provided. One system includes memory configured to store schematic data representing a schematic of the vehicle and a processor coupled to the memory and configured to execute the schematic data. The system further includes a display coupled to the processor and configured to output an image of the schematic, the image providing a transparent direct view of the vehicle and the systems. One method includes the steps of generating an image representing a schematic of the vehicle and the systems, the image providing a transparent direct view of the vehicle and the systems and selectively rotating the image such that a user is capable of viewing the vehicle and the systems from a plurality of angles. Also provided are machine-readable mediums including instructions for executing the above method.

### FIELD OF THE INVENTION

The present invention generally relates to vehicle computing systems, and more particularly relates to transparent vehicle skin and methods for viewing vehicle systems and operating status.

### BACKGROUND OF THE INVENTION

Contemporary systems and methods for monitoring vehicle systems and operating status typically provide a top-down view of the external features of the vehicle. In these systems and methods, users receive text messages of system alerts and the operating status of the monitored systems. As such, users are unable to view three-dimensional representations of the various systems operating within the vehicle because the systems and operating status are provided in a two-dimensional external view of the vehicle from a single angle.

Accordingly, it is desirable to provide transparent vehicle skin and methods for viewing vehicle systems and system alerts/operating status from a plurality of angles and in three dimensions. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments provide systems for viewing systems and status of a vehicle. One embodiment comprises memory configured to store schematic data representing a schematic of the vehicle and its systems, and a processor coupled to the memory and configured to execute the schematic data. This embodiment further comprises a display coupled to the processor and configured to output an image of the schematic, the image providing a transparent direct view of the vehicle and the systems.

Other embodiments provide methods for viewing systems and status of a vehicle. One method comprises the steps of generating an image representing a schematic of the vehicle and the systems, the image providing a transparent direct view of the vehicle and the systems and selectively rotating the image such that a user is capable of viewing the vehicle and the systems from a plurality of angles.

Other embodiments provide machine-readable mediums storing instructions that, when executed by a processor, cause the processor to perform a method. One such method comprises the steps of generating an image representing a schematic of the vehicle and the systems, the image providing a transparent direct view of the vehicle and the systems and selectively rotating the image such that a user is capable of viewing the vehicle and the systems from a plurality of angles.

### BRIEF DESCRIPTION OF THE DRAWINGS

The present invention will hereinafter be described in conjunction with the following drawing figures, wherein like numerals denote like elements, and

FIG. 1 is a block diagram of one embodiment of a vehicle comprising a system for viewing vehicle systems and the operating status of the vehicle systems via a transparent skin;

FIGS. 2A and 2B are diagrams of one embodiment of zoom in and zoom out views, respectively, of the vehicle of FIG. 1;

FIGS. 3A-3D are diagrams of one embodiment of user-selectable views of the vehicle of FIG. 1 during a runway-to-gate phase;

FIG. 4 is a diagram of one embodiment of the vehicle of FIG. 1 during a pre-flight phase;

FIG. 5 is a diagram of one embodiment of the vehicle of FIG. 1 during a gate-to-runway phase; and

FIG. 6 is a diagram of one embodiment of the vehicle of FIG. 1 during a rollout-after-landing phase.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various embodiments provide systems using a transparent vehicle skin to view vehicle systems and system alerts/operating status from a plurality of angles. Other embodiments provide methods for viewing vehicle systems and system alerts/operating status from a plurality of angles via a transparent vehicle skin.

The following discussion is made with reference to an aircraft; however, the concepts and principles of the present invention are applicable to other types of vehicles. That is, the concepts and principles discussed below are also applicable to terrestrial vehicles (e.g., automobiles, trucks, military vehicles, motorcycles, and the like terrestrial vehicles) and watercraft (e.g., ships, boats, submarines, and the like watercraft).

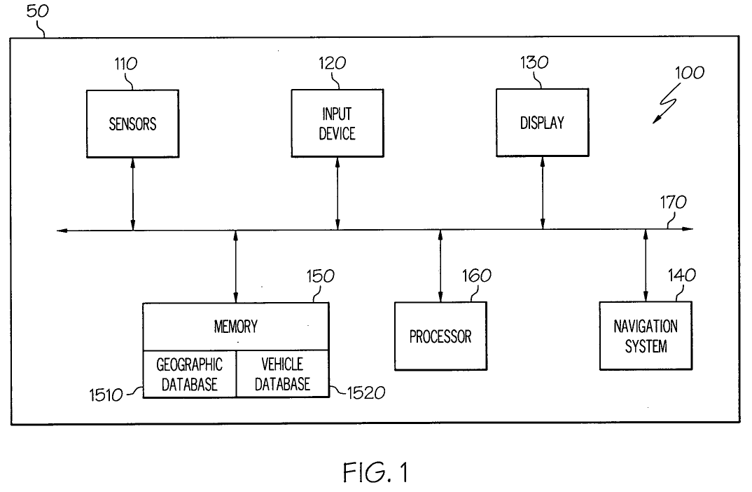

With reference now to the figures, FIG. 1 is a block diagram of one embodiment of a vehicle 50 (e.g., an aircraft, a terrestrial vehicle, a watercraft, etc.) comprising a system 100 for viewing vehicle systems and the operating status of the vehicle systems via a transparent skin. At least in the illustrated embodiment, system 100 includes a plurality of sensors 110, an input device 120, a display 130, a navigation system 140, memory 150, and a processor 160 coupled to one another via a bus 170 (e.g., a wired and/or wireless bus).

Sensors 110 are any type of system and/or device capable of detecting one or more physical attributes. For example, sensors 110 may be a temperature sensor, a position sensor (e.g., a door position sensor, a landing gear position sensor, a flap position sensor, etc.), an oil pressure sensor, a fuel level sensor, a brake sensor, a RADAR sensor, a light sensor, and/or the like sensors.

Input device 120 is any system and/or device capable of receiving user input. Examples of input device 120 include, but are not limited to, a keyboard, a mouse, a trackball, a joystick, a touchpad, a touch screen, and/or the like input devices.

Display 130 may be any type of display known in the art or developed in the future. In one embodiment, display 130 is integrated with input device 120 (e.g., a touch screen) such that a user is capable of directly or indirectly modifying the information being illustrated on display 130. As such, display 130 may be implemented in an aircraft flight deck, an interior of a terrestrial vehicle, or the bridge of a watercraft.

Navigation system 140 may be any system and/or device capable of determining the position of a vehicle on a global and/or local coordinate system. In one embodiment, navigation system 140 is a global positioning system (GPS) using commercially-available and/or militarily-available technologies.

Memory 150 may be any system, device, and/or medium capable of storing computer-readable instructions. In one embodiment, memory 150 stores a geographic location database 1510. In another embodiment, memory 150 stores a vehicle database 1520. Memory 150, in yet another embodiment, stores both geographic database 1510 and vehicle database 1520.

Geographic database 1510 includes two-dimensional (2-D) and/or three-dimensional (3-D) terrain, landmark, and/or other feature information for one or more geographic locations. In one embodiment, geographic database 1510 is an airport database including the features (e.g., runway features, taxiway features, terminal features, etc.) and the dimensions for such features for one or more airports. In another embodiment, geographic database 1510 is a roadway database including the features (e.g., bridges, tunnels, overpasses, underpasses, etc.) and the dimensions for such features for one or more roadways (e.g., freeway features, highway features, street features, parking lot features, etc.). In yet another embodiment, geographic database 1510 is a waterway database including the features (e.g., width, depth, etc.) for one or more waterways.

Vehicle database 1520 includes information related to one or more vehicles. That is, vehicle database 1520 may include a 2-D and/or 3-D scaled schematic (or model) of a specific vehicle (e.g. a specific aircraft, a specific automobile, a specific watercraft, etc.) including the shape and size of the vehicle, along with the location and dimensions of various systems (e.g., engine, brakes, wings, doors, RADAR, windows, etc.) included on the specific vehicle. In other words, vehicle database 1520 includes different information for different makes and models of aircraft, terrestrial vehicles, and watercraft depending on the application of system 100.

In addition to geometric information and properties about the system components, various embodiments of vehicle database 1520 include “normal” and “non-normal” component operation status. That is, vehicle database 1520 includes the operation status of various systems while the systems are functioning properly, as well as, the operation status and/or an alert related to the various systems in the unlikely event that one or more systems experience a malfunction. In one embodiment, the normal or non-normal status of a system may be conveyed using auditory, visual and tactile feedback, or any combination thereof.

Other embodiments of vehicle database 1520 show the movement of various components within a system during operation, whether the components are functioning properly or improperly. For example, a reverse thrust bucket may be shown in an open or closed state. Other examples of components showing movement or visual change include, but are not limited to, flaps, speed breaks, turbine blades, strobe lights, internal and external lighting systems, and the like systems included on an aircraft or other vehicle.

Processor 160 may be any system and/or device capable of executing the computer-readable instructions stored in memory 150 and performing the functions discussed below. In one embodiment, processor 160 is configured to retrieve the features of a specific vehicle from vehicle database 1520 and command display 130 to show an illustration of such specific vehicle. The illustrated vehicle may be shown in 2-D or 3-D such that a user is capable of rotating (via input device 120) or otherwise viewing the illustrated vehicle from one or more angles. Furthermore, the illustrated vehicle may include a transparent “skin” such that the user is capable of viewing the internal systems (e.g., engine system, heating/cooling system(s), braking system, hydraulic system, electrical system, fuel system, oil system, air pressure, etc.) and the operating status (e.g., ON/OFF state, functioning/malfunctioning state, position, etc.) of the various systems, as detected by one or more of sensors 110.

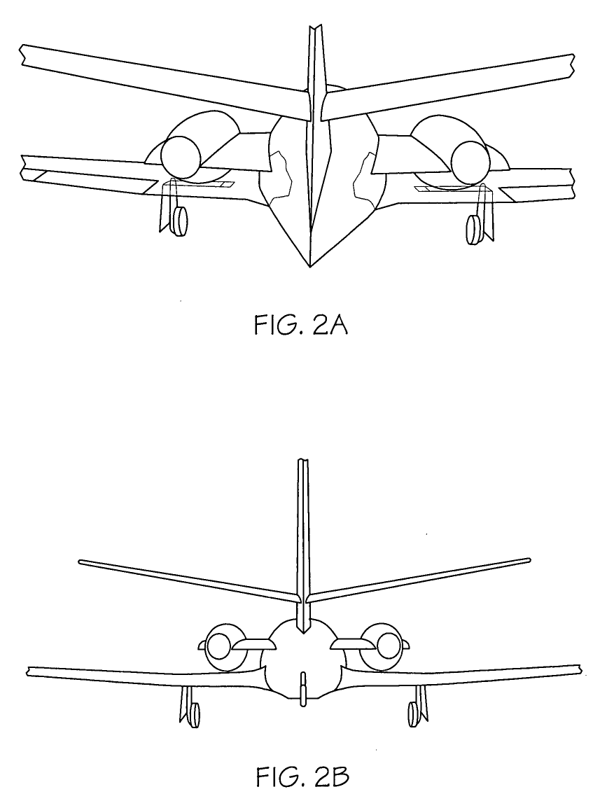

In viewing the internal systems of the vehicle, a user is able to use input device 120 to zoom in/out of various portions of the illustrated vehicle such that the user is capable of viewing the details of one or more specific systems and/or areas within the illustrated vehicle. Here, a selectable “de-clutter” function may be included such that larger features are filtered out as the user zooms in to a specific system/area of the vehicle (see FIG. 2A) and smaller features are filtered out as the user zooms out of the specific vehicle system/area (see FIG. 2B).

In various embodiments of system 100, the view of the illustrated vehicle may change depending upon a travel phase of the vehicle. That is, system 100 is configured to change the system views as the travel phases of the vehicle changes. Travel phases for an aircraft may include, for example, a runway-to-gate phase, a pre-flight phase, a gate-to-runway phase, in-flight phase, and a rollout-after-landing phase.

One embodiment of the runway-to-gate phase displays the aircraft with the systems and/or operating status of the systems that may be in use during the runway-to-gate phase. For example, the ground spoilers and status (e.g., up or down), autopilot (AP) and status (e.g., connect or disconnect), auto-brake and status (e.g., ON or OFF), auxiliary power unit (APU) start and status, strobe lights and status (e.g., ON or OFF), RADAR system and status (e.g., ON or OFF), landing lights and status (e.g., ON or OFF), taxi lights and status (e.g., ON or OFF), flap configuration (e.g., up or down), transponder and status (e.g., ON or OFF), parking brake and status (e.g., ON or OFF), external power, navigation lights and status (e.g., ON or OFF), beacon and status (e.g., ON or OFF), and/or the like systems/status may be displayed during the runway-to-gate phase of the flight.

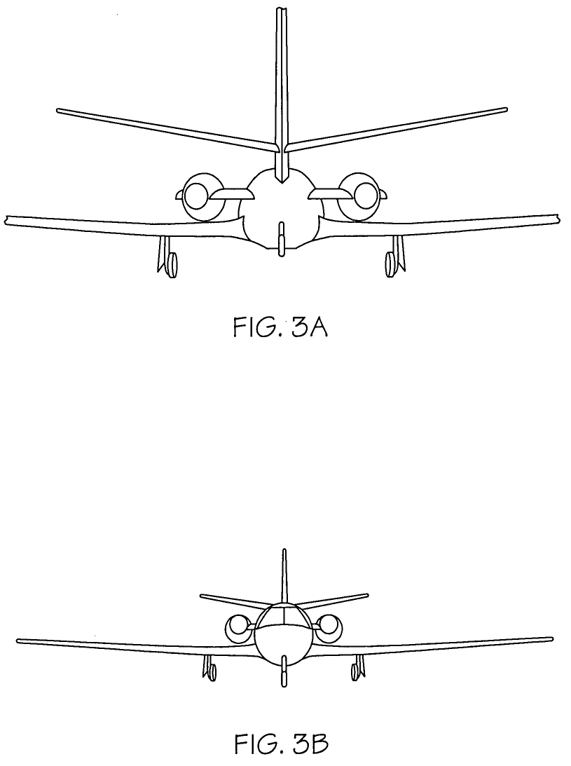

In the embodiment illustrated in FIGS. 3A-3D, an aircraft is displayed during the runway-to-gate phase of the flight. FIGS. 3A-3D also illustrate that the user (e.g., the pilot) is capable of selecting one or more views of the aircraft, which is also applicable to the other travel phases of the aircraft. Furthermore, the view of the aircraft in FIGS. 3A-3D is from an external or an “away” view (e.g., a third-person view) of the aircraft.

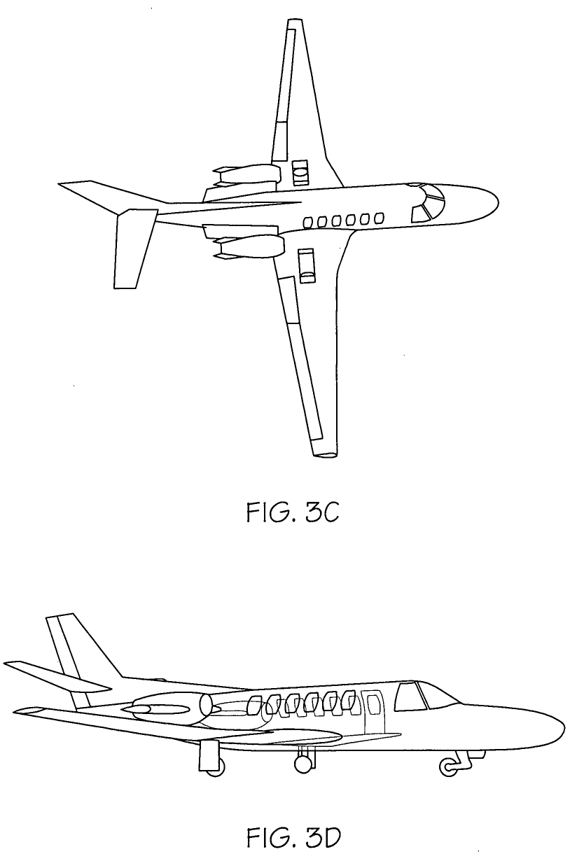

In one embodiment of the pre-flight phase, the aircraft is displayed with the systems and/or operating status of the systems that may be in use during the pre-flight phase. For example, the parking brake, the door(s), flight deck and cabin oxygen levels, fuel level, oil level and pressure, flap configuration, landing gear position(s), external lighting, an anti-ice system for the wings and/or engine(s), RADAR system, and/or the like systems/status may be displayed during the pre-flight phase of the aircraft. In the embodiment illustrated in FIG. 4, an aircraft is displayed showing a wing anti-ice system and an engine anti-ice system and a status (e.g., ON) for the wing anti-ice system and the engine anti-ice system during the pre-flight phase of the flight.

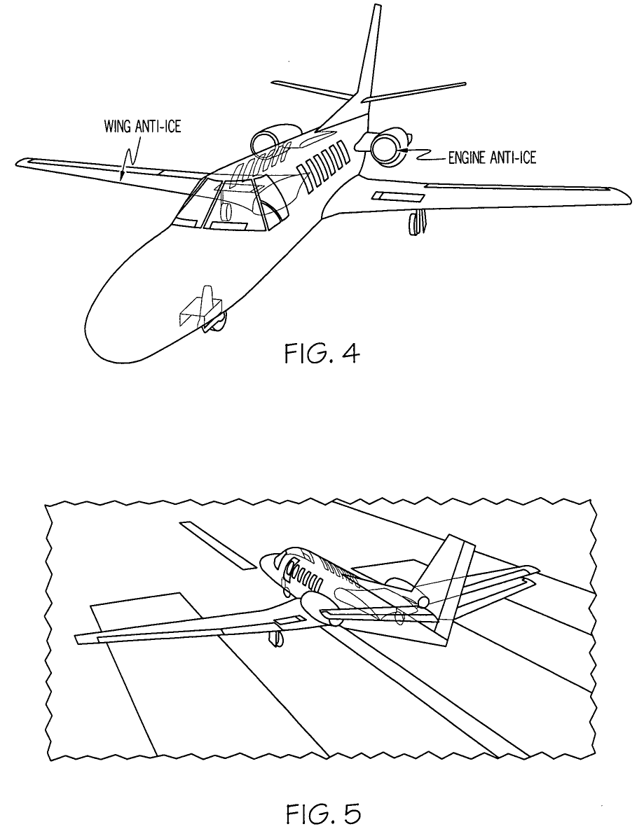

An embodiment of the gate-to-runway phase displays the aircraft with the systems and/or operating status of the systems that may be in use during the pre-flight phase. For example, the parking brake, the door(s), window temperature, wings, engine temperature, external lighting system, strobe lights, the aileron/stab/rudder trim, the ground spoiler position, reverse thrust locks, flap configuration, flight control checks, auto-brakes, and/or the like systems/status may be displayed during the gate-to-runway phase of the flight. In the embodiment illustrated in FIG. 5, the aircraft in shown in a take-off position on the runway.

The in-flight phase, in one embodiment, displays the aircraft with the systems and/or operating status of the systems that may be in use during the in-flight phase. For example, landing lights and status (e.g., ON or OFF), taxi lights and status (e.g., ON or OFF), the flap configuration (e.g., up or down), landing gear position and status (e.g., up or down), transponder and status (e.g., ON or OFF), external power, navigation lights and status (e.g., ON or OFF), beacon and status (e.g., ON or OFF), and/or the like systems/status may be displayed during the in-flight phase of the flight.

The rollout-after-landing phase, in one embodiment, displays the aircraft with the systems and/or operating status of the systems that may be in use during the rollout-after-landing phase. For example, the parking brake temperature and status (e.g., overheating), the ground spoiler position, the flap configuration, and/or the like systems/status may be displayed during the rollout-after-landing phase of the flight.

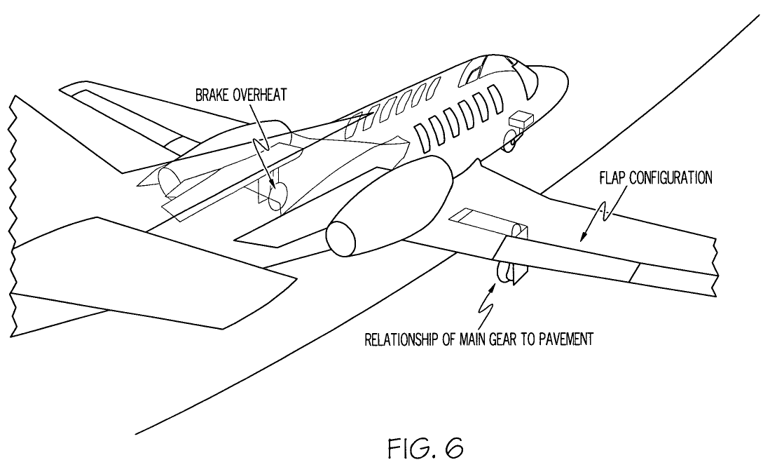

In the embodiment illustrated in FIG. 6, an aircraft is displayed showing a brake system and a status (e.g., brake overheat) for the brake system, a flap configuration, and the landing gear and a relationship of the landing gear to the runway during the rollout-after-landing phase of the flight. To obtain the relationship of the landing gear to the runway, processor 160 is configured to merge navigation data from navigation system 140, geographic data from geographic database 1510, and vehicle database 1520 to determine a position of the aircraft (obtained from navigation system 140) within the airport and to determine a position of the various aircraft features (obtained from vehicle database 1520) in relation to the various features of the airport (obtained from geographic database 1510). In the embodiment illustrated in FIG. 6, after merging navigation data from navigation system 140, geographic data from geographic database 1510, and vehicle database 1520, processor 160 determined that the position of the right wheel of the aircraft is off of the runway, which relationship is capable of being viewed from above and behind the aircraft, although other views may be available by rotating the aircraft image and/or by selecting to view the aircraft from one or more different views (see e.g., FIGS. 3A-3D).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A system for viewing systems and status of a vehicle, comprising:
memory configured to store schematic data representing a schematic of the vehicle;
a processor coupled to the memory and configured to execute the schematic data; and
a display coupled to the processor and configured to output an image of the schematic, the image providing a transparent direct view of the vehicle and the systems.

2. The system of claim 1, wherein the image provides a three-dimensional (3-D) transparent direct view of the vehicle and the systems.

3. The system of claim 2, wherein the processor is configured to enable a user to rotate the 3-D image such that the user is capable of viewing the vehicle and the systems from a plurality of angles.

4. The system of claim 3, wherein the processor is configured to enable a user to zoom in/out of portions of the 3-D image.

5. The system of claim 1, further comprising:
a global position system (GPS) coupled to the processor; and
a geographic database stored in the memory and comprising data representing features of geographic locations, the processor configured to determine an external view of the vehicle based on a position of the vehicle determined by the GPS and features of a present geographic location of the vehicle stored in the geographic database.

6. The system of claim 5, wherein the processor is configured to determine a relationship between features of the vehicle and the features of the present geographic location.

7. The system of claim 6, wherein the vehicle is an aircraft and the present geographic location is an airport.

8. The system of claim 5, wherein the vehicle is an aircraft and the memory comprises logic to determine a location/flight status of the aircraft.

9. The system of claim 8, wherein the processor is configured to command the display to output the image based on a phase of the location/flight status of the aircraft.

10. The system of claim 9, wherein the processor is configured to command the display to output an in-flight external view of the aircraft during an in-flight phase.

11. The system of claim 9, wherein the processor is configured to command the display to output a ground external view of the aircraft during a ground phase.

12. The system of claim 1, further comprising a plurality of sensors coupled to the systems, the processor configured to receive sensor data from the plurality of sensors and update the schematic in real time based on received sensor data.

13. A method for viewing systems and status of a vehicle, the method comprising the steps of:
generating an image representing a schematic of the vehicle and the systems, the image providing a transparent direct view of the vehicle and the systems; and
selectively rotating the image such that a user is capable of viewing the vehicle and the systems from a plurality of angles.

14. The method of claim 13, wherein the generating step comprises the step of generating a three-dimensional (3-D) image of the schematic.

15. The method of claim 14, further comprising the step of zooming in/out of portions of the 3-D image.

16. The method of claim 14, further comprising the step of determining an external view of the vehicle based on a determined position of the vehicle and features of a present geographic location of the vehicle.

17. A machine-readable medium storing instructions that, when executed by a processor, cause the processor to perform a method comprising the steps of:
generating an image representing a schematic of the vehicle and the systems, the image providing a transparent direct view of the vehicle and the systems; and
selectively rotating the image such that a user is capable of viewing the vehicle and the systems from a plurality of angles.

18. The machine-readable of claim 17, wherein the instructions that cause the processor to perform the generating step comprise instructions that, when executed by the processor, cause the processor to perform the step of generating a three-dimensional (3-D) image of the schematic.

19. The machine-readable medium of claim 18, further comprising instructions that, when executed by the processor cause the processor to perform the step of zooming in/out of portions of the 3-D image.

20. The machine-readable medium of claim 18, further comprising instructions that, when executed by the processor cause the processor to perform the step of determining an external view of the vehicle based on a determined position of the vehicle and features of a present geographic location of the vehicle.
